(19) United States
(12) Patent Application Publication
(10) Pub. No.: US 2013/0020244 A1
(43) Pub. Date: Jan. 24, 2013

(54) FILTER PRESS

(71) Applicant: Herbert Schulte, Euskirchen (DE)

(72) Inventor: Herbert Schulte, Euskirchen (DE)

(73) Assignee: Gölz GmbH, Hellenthal-Blumenthal (DE)

(21) Appl. No.: 13/541,456

(22) Filed: Jul. 3, 2012

(30) Foreign Application Priority Data
Jul. 4, 2011 (DE) 202011050628.2

(51) Int. Cl. B01D 25/19; B01D 25/21; B01D 25/164

(52) U.S. Cl. 210/228

(57) ABSTRACT

A filter press including a top plate and an end plate that are connected by at least one connecting rod with the interposition of a packet of chamber plates. Between adjacent pairs of chamber plates, a respective filter chamber can be produced and a clamping device is provided, which is able to bring the chamber plates into an operating position in which the filter chambers are pressed against one another in a sealed fashion and to release the chamber plates into an open position in which the filter chambers are openable, wherein a removable spacer plate and a clamping device in the form of a pressing unit that can be acted on with a working fluid are provided between the top plate and the end plate.

### BACKGROUND OF THE INVENTION

1. Field of the Invention

This invention relates to a filter press including a top plate and an end plate that are connected to each other by at least one connecting rod with the interposition of a packet of chamber plates; between adjacent pairs of chamber plates, a respective filter chamber can be produced and a clamping device is provided, which can bring the chamber plates into an operating position in which they are pressed against one another so that they seal the filter chambers and release the chamber plates into an open position in which the filter chambers are openable.

2. Discussion of Related Art

Filter presses are known, for example, from PCT International Publication WO 2010/092612 A1 and German Patent Reference DE 199 04 637 C1 and are used to separate the solid portion from the fluid portion of suspensions such as solids-laden fluids, such as cooling fluid and drilling fluid of concrete saws and concrete drills, so that the water used for cooling and flushing can be freed of the solids and disposed of in the sewer system while the solids are retained and can be taken to a landfill or a recycling center.

The previously known devices, which are also referred to as chamber filter presses, clamp the chamber plates together using hydraulic or pneumatic cylinders and sometimes also mechanically complex knuckle joints in order to achieve the contact pressure required to seal the chamber plates enclosing a respective filter chamber, and also to ensure that in the open position, enough clearance is provided to permit the filter chambers to be opened and the filter cake that has accumulated in them to be removed. For this reason, the known devices are not only technically complex and therefore cost-intensive, but also have a disadvantageous size that makes it difficult or impossible to transport or install them in cramped spaces, such as cellars or basement corridors and to transport them up and down staircases.

### SUMMARY OF THE INVENTION

One object of this invention is to overcome disadvantages of the prior art and to propose an efficient, but particularly compact filter press that can even be brought into rooms with small doorways, preferably by only one person, and can also be transported in a conventional passenger vehicle.

In order to attain the above object and others, this invention provides one embodiment of the filter press according to features discussed in this specification and in the claims.

This invention provides a removable spacer plate and a clamping device in the form of a pressing unit, which can be acted on with a working fluid, between the top plate and the end plate. This produces a highly compact design whose spatial requirements can be determined by the distance between the top plate and end plate because all remaining functional parts, such as the packet of chamber plates and the clamping device in the form of the pressing unit and the removable spacer plate are situated between the top plate and the end plate.

In one embodiment of this invention, it is possible for the pressing unit to include an air cushion that can be acted on with compressed air, which is used as the working fluid. When acted on with the easily producible compressed air as the working fluid, air cushions of this type produce a very high contact pressure on the chamber plates, which is required for producing a good seal of the filter chambers that can be produced between them, but the compressive force that such a pressing unit can exert decreases rapidly with increasing expansion because the bearing surface of the air cushion decreases. The spacer plate provided according to this invention makes it possible to minimize the pressing unit stroke required to produce the pressing force in the closed position and to exploit the full force of the stroke. If the chamber plates are to be brought into their open position, the small stroke of the pressing unit provided according to this invention would not be sufficient for the task, which is why this invention can have the spacer plate in a removable fashion between the top plate and end plate so that after removal of the spacer plate, a sufficient movement clearance is produced between the chamber plates and the pressing unit, thus permitting a trouble-free transfer of the individual chamber plates into the open position for a removal of the filter cake from the filter chamber.

According to one embodiment of this invention, the thickness of the spacer plate is dimensioned so that it at least corresponds to the distance between the open position and the operating position of the chamber plates in order to achieve sufficient movement clearance upon removal of the spacer plate.

According to one embodiment of this invention, the pressing unit and the spacer plate are situated adjacent to the packet of chamber plates.

According to another embodiment, a pressing plate is provided between the pressing unit and the spacer plate so that in an additionally advantageous fashion, the pressing unit can expand between the top plate or the end plate and the pressing plate adjacent to it and can produce the desired compressive force between them.

The chamber plates and the spacer plate as well as the pressing plate also can be affixed to at least one connecting rod, for example can be hooked to it by protruding retaining arms.

According to one embodiment of this invention, the spacer plate can be of or comprise one piece or alternatively can be of multiple pieces, for example divided horizontally or vertically.

According to one embodiment of this invention, the working fluid can be compressed air. It is also possible, however, to select other working fluids. Also, the use of compressed air offers one advantage that the compressed air can also be used to operate the suspension pump that conveys the suspension to be filtered, for example a compressed air diaphragm pump.

### BRIEF DESCRIPTION OF THE DRAWINGS

Other embodiments and details of this invention are explained in greater detail below in view of an exemplary embodiment shown in the drawings, wherein:

FIG. 1 is a perspective view of a filter press according to one embodiment of this invention;

FIG. 2 is a side view of the filter press according to FIG. 1;

FIG. 3 is a section view taken through the filter press according to FIG. 2, with the chamber plates in the operating position;

FIG. 4 is a top view of the filter press according to FIG. 2;

FIG. 5 is a side view of the filter press according to FIG. 2, with the spacer plate removed; and

FIG. 6 shows removal of a filter cake from the filter press according to FIG. 5.

### DETAILED DESCRIPTION OF THE INVENTION

The figures show a filter press that is labeled as a whole with reference numeral 1 and that is delimited at its two ends by a top plate 10 and an end plate 15. Between the top plate 10 and the end plate 15, there is a series of chamber plates 11, which are combined to form a packet and are explained in greater detail below, a spacer plate 12, a pressing plate 13, and a pressing unit 14 serving as a clamping device. The top plate 10 is connected to the end plate 15 by connecting rods 16, which are inserted through corresponding holes in the top plate 10 and the end plate 15 and secured by or by means of nuts 160, and the top plate 10 and the end plate 15 are fixed in position relative to each other.

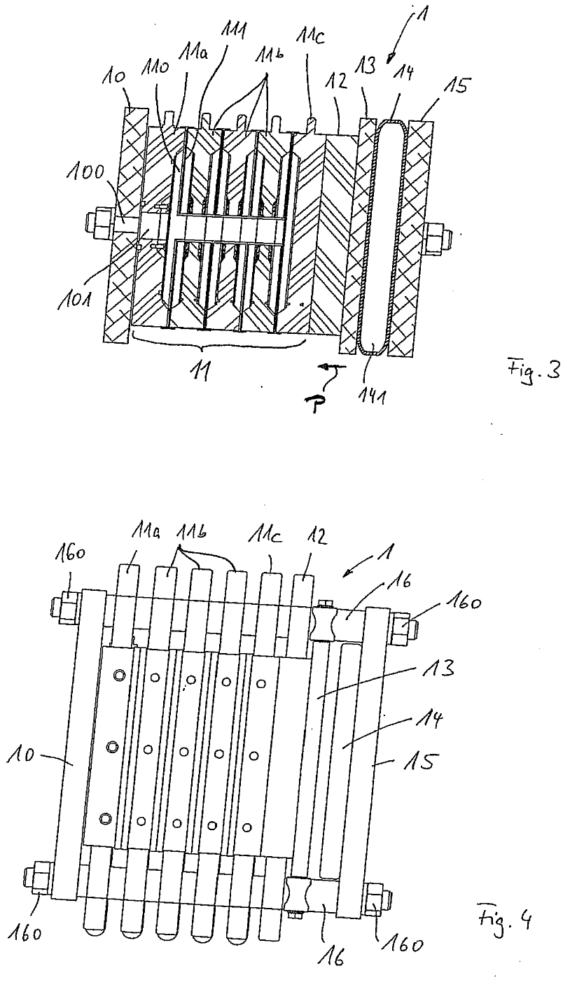

As shown in FIGS. 2 and 3, adjacent to the top plate 10, the chamber plates 11 first have a top chamber plate labeled with the reference numeral 11a, which is adjoined by a total of three middle chamber plates 11b in the direction toward the end plate 15, which are then adjoined by an end chamber plate 11c adjacent to the spacer plate 12. Between the top chamber plate 11a and the adjacent middle chamber plate 11b, between the subsequent middle chamber plates 11b adjoining them, and between them and the subsequent end chamber plate 11c, a respective filter chamber 110 can be produced, which also accommodates a filter cloth 111.

The pressing unit 14 comprises an air cushion that can be acted on with compressed air used as a working fluid; and the working fluid can be conveyed into and out of the interior 141 of the pressing unit 14 via a compressed air connection 140.

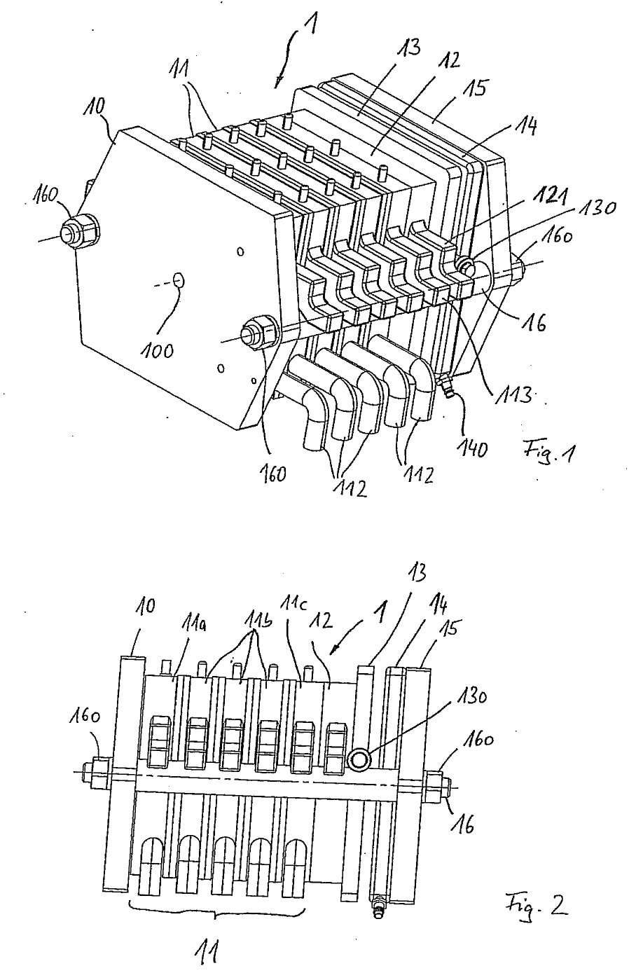

FIG. 3 shows the pressing unit in the inflated state, for example when acted on with pressurized working fluid, in which state the pressing unit 14 is supported against the end plate 15 and as a result, exerts a pressure in the direction of the arrow P on the pressing plate 13 and from there, via the spacer plate 12, onto the above-explained packet of chamber plates 11, which are in turn pressed against the top plate 10. As a result of this compressive force, the individual chamber plates 11a, 11b, 11c are pressed against each other with the required contact pressure so that in such closed positions, the filter chambers 110 produced between the chamber plates are sealed. A suspension to be filtered can then be introduced via a central inlet bore 100, which can be seen for example in FIGS. 1 and 3, into a central conduit 101 inside the packet of chamber plates 11 and the fluid then exits at outlet fittings 112 located on the side while solids remain behind in the filter chambers 110 and gradually form a filter cake.

In addition, FIGS. 1 and 2 show that the chamber plates 11 are supported on the connecting rods 16 by or by means of laterally protruding retaining arms 113. The spacer plate 12 is likewise supported on the connecting rods 16 by analogously embodied retaining arms 121.

If during continuous operation of filter presses embodied in this way, the filter chambers 110 have gradually been filled with retained solid materials, a filter cake has formed, and the flow quantity of suspension to be filtered has decreased correspondingly, it then becomes necessary to clean out the filter chambers 110.

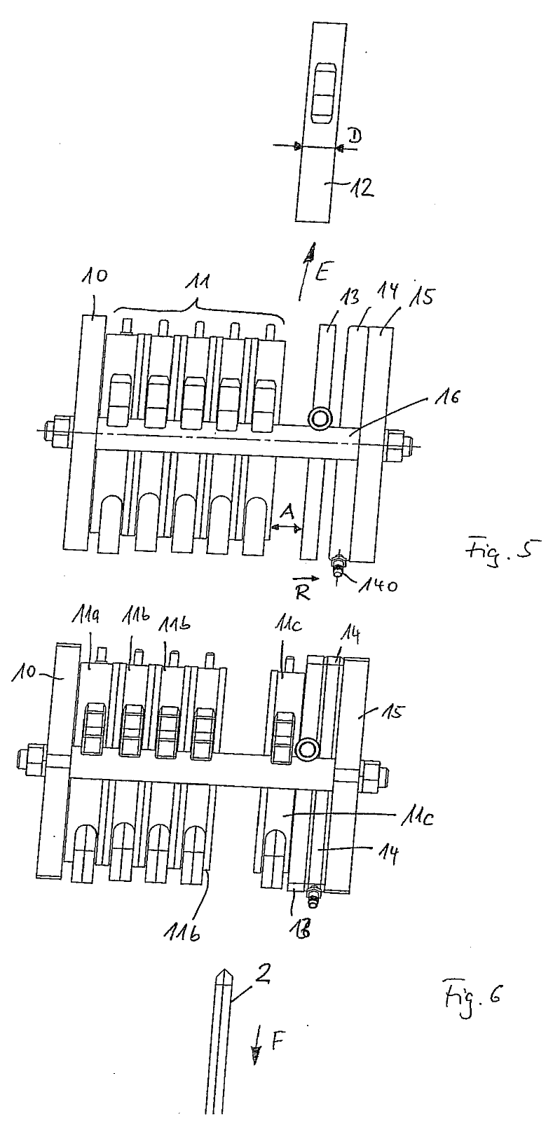

For this purpose, first, the action of working fluid on the pressing unit 14 is interrupted, whereupon it returns from the inflated position shown in FIG. 3, which corresponds to the operating position of the chamber plates 11, to a relaxed position that is shown for example in FIGS. 2 and 4 in which there is a slight gap between the pressing unit 14 and the pressing plate 13. It is clear that the pressing plate 13 is guided by or by means of rollers 130 in sliding fashion along the longitudinal axis of the connecting rods 16 so that the pressing plate 13 can be moved, as shown in FIG. 5, to the right in the direction of the arrow R toward the pressing unit 14. Then the spacer plate 12 can be removed in the direction of the arrow E from its position between the packet of chamber plates 11 and the pressing plate 13; and the spacer plate 12 is dimensioned in its thickness D so that it at least corresponds to the distance A between the closed position of the chamber plates 11 and an open position of the latter in which the filter chambers 110 are open and therefore accessible.

Consequently, after the removal of the spacer plate 12, as shown for example in FIG. 6, the end chamber plate 11c can be slid to the right along with the pressing plate 13 until they both contact or come into contact with the pressing unit 14 against the end plate 15, thus producing a clearance in relation to the adjacent middle chamber plate 11b, permitting the filter cake 2 to be removed from the associated filter chamber in the direction of the arrow F in FIG. 6. After this, the middle chamber plate 11b adjacent to the end chamber plate 11 c can then be slid to the right until it contacts or comes into contact with the latter, whereupon the filter chamber between the two adjacent middle chamber plates 11b becomes accessible and so forth until finally, the filter cakes 2 have been removed from all of the filter chambers between the individual chamber plates 11. After all of the chamber plates 11 have been returned to their initial position and the spacer plate 12 has been reinserted, the pressing unit 14, by executing an extremely small working stroke, can once again exert the required contact pressure on the chamber plates 11 in order to seal them and the filtering process begins anew.

It is clear that the filter press explained above is able to function with extremely small dimensions so that it can be inserted in a space-saving fashion into a unit that can be moved by one person, for example mounted on a carriage, even in cramped conditions and can be placed into operation there with very little effort. This makes it possible to use the filter press in virtually any installation site, its small dimensions and low weight also permitting it to be easily transported in conventional passenger vehicles.

German Patent Reference No. 20 2011 050 628.2, filed 04 Jul. 2011, the priority document corresponding to this invention, to which a foreign priority benefit is claimed under Title 35, United States Code, Section 119, and its entire teachings are incorporated, by reference into this specification.

1. A filter press (1) comprising a top plate (10) and an end plate (15) connected by at least one connecting rod (16) with an interposition of a packet of chamber plates (11), between adjacent pairs of chamber plates (11) a respective filter chamber (110) and a clamping device is provided which is able to bring the chamber plates (11) into an operating position in which the filter chambers (110) are pressed against one another in a sealed fashion and to release the chamber plates into an open position in which the filter chambers (110) are openable, and a removable spacer plate (12) and a clamping device formed as a pressing unit (14) actionable with a working fluid provided between the top plate (10) and the end plate (15).

2. The filter press (1) as recited in claim 1, wherein a thickness (D) of the spacer plate (12) is dimensioned to correspond to a distance (A) between the open position and the operating position of the chamber plates (11).

3-7. (canceled)

8. The filter press (1) as recited in claim 2, wherein the pressing unit (14) and the spacer plate (12) are adjacent to the packet of chamber plates (11).

9. The filter press (1) as recited in claim 8, wherein a pressing plate (13) is provided between the pressing unit (14) and the spacer plate (12).

10. The filter press (1) as recited in claim 9, wherein the chamber plates (11) and the spacer plate (12) as well as the pressing plate (13) are affixable to the at least one connecting rod (16).

11. The filter press (1) as recited in claim 10, wherein the spacer plate (12) is one piece or multiple pieces.

12. The filter press (1) as recited in claim 11, wherein the pressing unit (14) comprises an air cushion that can be acted on with compressed air as a working fluid.

13. The filter press (1) as recited in claim 1, wherein the pressing unit (14) and the spacer plate (12) are adjacent to the packet of chamber plates (11).

14. The filter press (1) as recited in claim 1, wherein a pressing plate (13) is provided between the pressing unit (14) and the spacer plate (12).

15. The filter press (1) as recited in claim 1, wherein the chamber plates (11) and the spacer plate (12) as well as the pressing plate (13) are affixable to the at least one connecting rod (16).

16. The filter press (1) as recited in claim 1, wherein the spacer plate (12) is one piece or multiple pieces.

17. The filter press (1) as recited in claim 1, wherein the pressing unit (14) comprises an air cushion that can be acted on with compressed air as a working fluid.
